(19) United States
(12) Patent Application Publication
(10) Pub. No.: US 2026/0223269 A1
(43) Pub. Date: Jul. 30, 2026

(54) LIGHTING SYSTEM HAVING INTELLIGENT PREDICTING FUNCTION

(71) Applicant: Xiamen PVTECH Co., Ltd., Xiamen (CN)

(72) Inventors: FUXING LU, Xiamen (CN); CHUNMING LIU, Xiamen (CN); CHENGQUAN XU, Xiamen (CN)

(21) Appl. No.: 19/531,722

(22) Filed: Feb. 6, 2026

Related U.S. Application Data
(63) Continuation-in-part of application No. 18/113,599, filed on Feb. 23, 2023, now abandoned.

(30) Foreign Application Priority Data
Nov. 24, 2022 (CN) 202211486234.2

(51) Int. Cl. H05B 47/155; H05B 47/115; H05B 47/16; H05B 47/175; H05B 47/19

(52) U.S. Cl. CPC H05B 47/155; H05B 47/115; H05B 47/16; H05B 47/19; H05B 47/198

(57) ABSTRACT

A lighting system includes a plurality of lighting devices and at least one intelligent predicting sensing device. Each of the lighting devices stores a plurality of lighting group setting values. One of the lighting group setting values of any one of the lighting devices is identical to one of the lighting group setting values of the lighting device adjacent thereto. The intelligent predicting sensing device stores a sensing group setting value. The sensing group setting value is identical to one of the lighting group setting values of the lighting device adjacent thereto. The intelligent predicting sensing device, upon detecting a moving object, broadcasts a first sensing signal having the sensing group setting value. The lighting device receiving the first sensing signal is activated according to the first sensing signal and broadcasts a first trigger signal. The first trigger signal has the lighting group setting values of the lighting device.

### TECHNICAL FIELD

The present invention relates to a lighting system, in particular to a lighting system having intelligent predicting function.

### BACKGROUND

With advance of technology, lighting technology with intelligent sensing function is becoming more and more popular. Currently, lighting devices can be integrated with various applications (APPs) and wireless controlling technologies (such as ZigBee, Wi-Fi, Bluetooth, NFC, etc.) in order to provide different functions.

However, the intelligent sensing functions of currently available lighting devices still have many shortcomings to be improved. For example, the controller of a currently available lighting device can detect a user approaching the lighting device through a motion sensor (such as a microwave sensor, infrared sensor, laser sensor, etc.) and turn on the light source of the lighting device so as to provide the lighting function. However, the user can still perceive the process of switching the lighting device from the off state to the on state. Therefore, the currently available lighting device with intelligent sensing function still cannot turn on the light source of the lighting device in advance before the user reaches the lighting range of the lighting device.

In addition, in addition, currently available lighting devices with intelligent sensing functions are unable to effectively predict a user's traveling path, and therefore cannot effectively reduce power consumption of the lighting devices, nor ensure sufficient illumination along the user's traveling path.

### SUMMARY

One embodiment of the present invention provides a lighting device having intelligent predicting function, which includes a plurality of lighting devices and at least one intelligent predicting sensing device. The lighting devices are distributed in a target area. Each of the lighting devices stores a plurality of lighting group setting values, and one of the lighting group setting values of any one of the lighting devices is identical to one of the lighting group setting values of the lighting device adjacent thereto. The intelligent predicting sensing device is disposed in the target area and in communication with at least one of the lighting devices. The intelligent predicting sensing device stores a sensing group setting value, and the sensing group setting value is identical to one of the lighting group setting values of the lighting device adjacent thereto. The intelligent predicting sensing device broadcasts, upon detecting a moving object, a first sensing signal having the sensing group setting value, and the lighting device receiving the first sensing signal is activated and to broadcast a first trigger signal based on the first sensing signal. The first trigger signal has the lighting group setting values of the lighting device receiving the first trigger signal.

As described above, the lighting system has an intelligent predicting mechanism based on lighting group settings, which not only enables lighting devices to be pre-activated upon detection of a moving object (such as a person or a vehicle), but also allows accurate prediction of a traveling path of the moving object. Accordingly, the lighting devices can sequentially and in advance provide sufficient illumination along the traveling path, such that the user does not perceive abrupt changes caused by transitions of the lighting devices from the off state to the on state during actual movement, thereby significantly improving comfort and safety during walking or driving. Therefore, the lighting system effectively satisfies actual requirements.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The present invention will become more fully understood from the detailed description given herein below and the accompanying drawings which are given by way of illustration only, and thus are not limitative of the present invention and wherein:

FIG. 1 is a block diagram of a lighting system having intelligent predicting function in accordance with a first embodiment of the present invention.

FIG. 2 is a block diagram of a lighting device having intelligent predicting function and an intelligent predicting sensing device in accordance with the first embodiment of the present invention.

FIG. 3 is a schematic view of an operational process of the lighting system having intelligent predicting function in accordance with the first embodiment of the present invention.

FIG. 4A~FIG. 4E are schematic views of an operational process of a lighting system having intelligent predicting function in accordance with a second embodiment of the present invention.

FIG. 5 is a block diagram of a lighting device having intelligent predicting function and an intelligent predicting sensing device in accordance with a third embodiment of the present invention.

FIG. 6 is a flow chart of an operational mechanism of the lighting device having intelligent predicting function in accordance with a fourth embodiment of the present invention.

FIG. 7 is a block diagram of a lighting system having intelligent predicting function in accordance with a fifth embodiment of the present invention.

FIG. 8 is a block diagram of a lighting device having intelligent predicting function in accordance with the fifth embodiment of the present invention.

FIG. 9 is a first schematic views of an operating state of the lighting system having intelligent predicting function in accordance with the fifth embodiment of the present invention.

FIG. 10 is a second schematic views of the operating state of the lighting system having intelligent predicting function in accordance with the fifth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

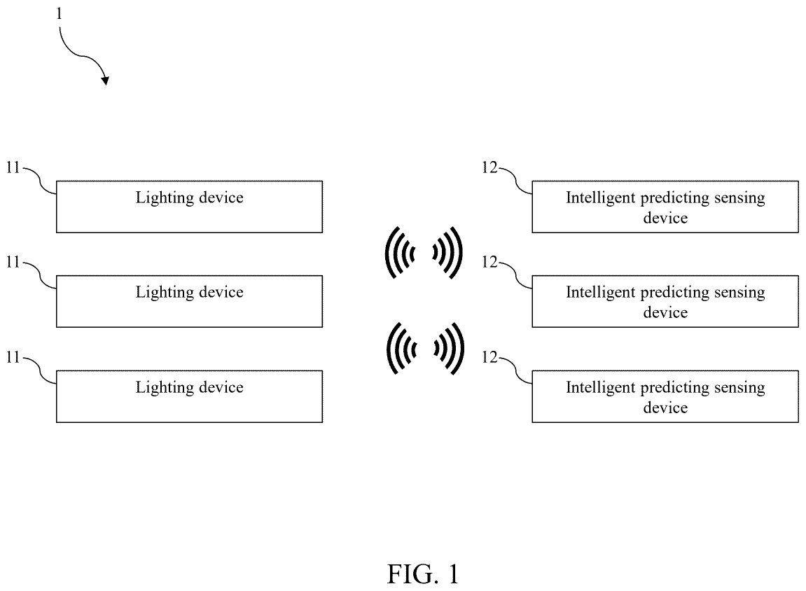

Please refer to FIG. 1, which is a block diagram of a lighting system having intelligent predicting function in accordance with a first embodiment of the present invention. As shown in FIG. 1, the lighting system 1 includes a plurality of lighting devices 11 and a plurality of intelligent predicting sensing devices 12. Each of the lighting devices 11 can communicate with one or more of the intelligent predicting sensing devices 12. There is a certain distance between any one of the intelligent predicting sensing devices 12 and any one of the lighting devices 11.

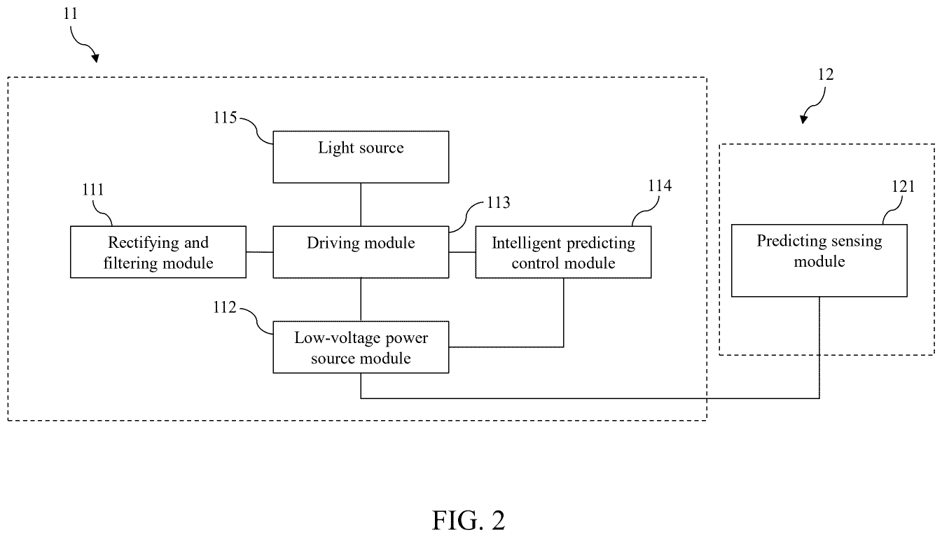

Please refer to FIG. 2, which is a block diagram of a lighting device having intelligent predicting function and an intelligent predicting sensing device in accordance with the first embodiment of the present invention. As shown in FIG. 2, the lighting device 11 includes a rectifying and filtering module 111, a low-voltage power source module 112, a driving module 113, an intelligent predicting control module 114 and a light source 115.

The rectifying and filtering module 111 is connected to an external power source (e.g., utility power) and is further connected to the driving module 113 in order to power the driving module 113. In one embodiment, the rectifying and filtering module 111 may include one or more of a rectifying circuit, an EMI circuit, a filtering circuit, a surge protecting circuit, which can power the main circuit of the lighting device 1 so as to make sure that the main circuit can normally operate.

The driving module 113 is connected to the low-voltage power source module 112, the intelligent predicting control module 114 and the light source 115. The driving module 113 powers the low-voltage power source module 112 and the light source 115, and the low-voltage power source module 112 powers the intelligent predicting control module 114. In one embodiment, the driving module 113 may be any one of currently available driving circuits. In one embodiment, the light source 115 may be a light-emitting diode (LED) or other currently available light sources. In one embodiment, the low-voltage power source module 112 may be a safe low-voltage power source or other similar components. In one embodiment, the intelligent predicting control module 114 may be a central-processing unit (CPU), a microcontroller unit (MCU), an application specific integrated circuit (ASIC) or other similar components.

The intelligent predicting sensing devices 12 are disposed to be away from the lighting devices 11. Any one of the lighting devices 11 can wirelessly communicate with the corresponding intelligent predicting sensing device 12 or any one of the intelligent predicting sensing devices 12 via the intelligent predicting control module 114 thereof. In the embodiment, the intelligent predicting sensing device 12 includes a predicting sensing module 121 connected to the low-power power source module 112, such that the low-voltage power source module 112 can power the predicting sensing module 121. The predicting sensing module 121 may be a microwave laser module, human body infrared module, RF module or other similar components. In another embodiment, the predicting sensing module 121 may not be connected to the utility power rather than the low-voltage power source module 112. In another embodiment, the lighting device 11 can wiredly communicate with the intelligent predicting sensing device 12 via the intelligent predicting control module 114 thereof.

The predicting sensing module 121 of the intelligent predicting sensing device 12 can generate a first sensing signal after detecting a moving object (e.g., the user) and transmit the first sensing signal to the intelligent predicting control module 114 of the corresponding lighting device 11. Then, the intelligent predicting control module 114 can turn on the light source 115 via the driving module 113. Thus, the user does not perceive the process of switching the lighting device 11 from the off state to the on state. In this way, the lighting device 11 can turn on the light source 115 of the lighting device 11 in advance before the user reaches the lighting range of the lighting device 11, which can significantly improve the user experience.

Similarly, the intelligent predicting sensing device 12 disposed at another position can generate a second sensing signal after detecting the moving object and transmits the second sensing signal to the intelligent predicting control module 114 of the corresponding lighting device 11. In this case, the intelligent predicting control module 114 can calculate a delay time according to the moving speed of the moving object. Afterward, the intelligent predicting control module 114 can turn off the light source 115 via the driving module 13 after the delay time passes. Accordingly, the user does not perceive the process of switching the lighting device 11 form the on state to the off state.

As described above, the lighting system 1 includes a plurality of lighting devices 11 and a plurality of intelligent predicting sensing devices 12. Any one of the lighting devices 11 includes the intelligent predicting control module 114 to communicate with any one of the intelligent predicting sensing devices 12 in order to product the intelligent predicting function. Thus, the user does not perceive the process of switching the lighting device 11 form the off state to the on state. In addition, the intelligent predicting function of the intelligent predicting control module 114 can calculate the delay time according to the moving speed of the moving object in order to estimate the time of the user leaving the lighting range of the lighting device 11. Therefore, the user does not perceive the process of switching the lighting device form the on state to the off state. The intelligent predicting control module 114 of the lighting device 11 can perform the intelligent complex calculation according to the sensing signal and sensitivity of the intelligent predicting sensing devices 12 to control the light source 115 with a view to enhancing the operating performance of the light source 115.

Moreover, the lighting devices 11 and intelligent predicting sensing devices 12 of the lighting system 1 can be connected to one another so as to form a network. As a result, the above intelligent predicting sensing devices 12 can properly turn on or turn off the lighting devices 11. Thus, when the user walks along a path, the path can be always lighted up. Further, the user does not perceive the process of switching the lighting device form the on state to the off state or from the off state to the on state. Moreover, the network can further provide various intelligent control functions via the complex control mechanism with an eye to meeting actual requirements.

The embodiment just exemplifies the present invention and is not intended to limit the scope of the present invention; any equivalent modification and variation according to the spirit of the present invention is to be also included within the scope of the following claims and their equivalents.

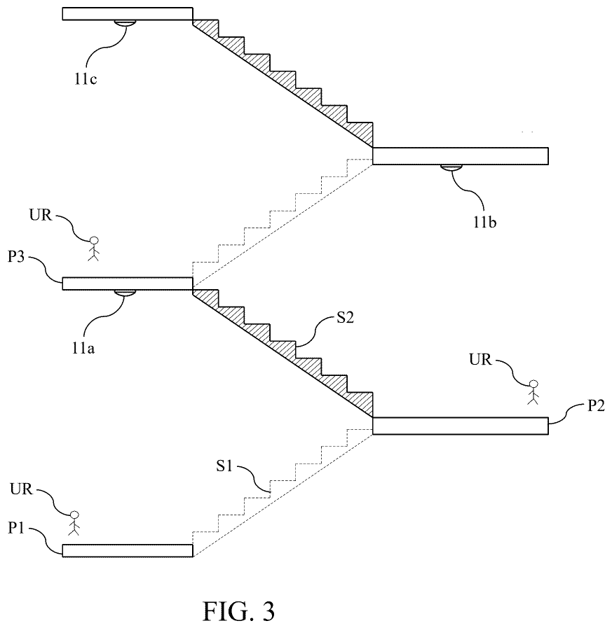

Please refer to FIG. 3, which is a schematic view of an operational process of the lighting system having intelligent predicting function in accordance with the first embodiment of the present invention. As shown in FIG. 3, when the user UR is approaching the first lighting device 11a, one of the intelligent predicting sensing devices 12 (not shown in FIG. 3) detects the user UR, and then generates the first sensing signal and transmits the first sensing signal to the lighting device 11a so as to turn on the lighting device 11a in advance. Therefore, when the user UR reaches the landing P1, the lighting device 11a has been in the on state. When the user passes through the flight S1, one of the intelligent predicting sensing devices 12 (not shown in FIG. 3) detects the user UR, and then generates the first sensing signal and transmits the first sensing signal to the lighting device 11b so as to turn on the lighting device 11b in advance. Therefore, when the user UR reaches the landing P2, the lighting device 11b has been in the on state. Similarly, when the user passes through the flight S2, one of the intelligent predicting sensing devices 12 (not shown in FIG. 3) detects the user UR, and then generates the first sensing signal and transmits the first sensing signal to the lighting device 11c so as to turn on the lighting device 11c in advance. Therefore, when the user UR reaches the landing P3, the lighting device 11c has been in the on state. Via the above mechanism, the user does not perceive the process of switching the lighting devices 11a, 11b, 11c from the off state to the on state.

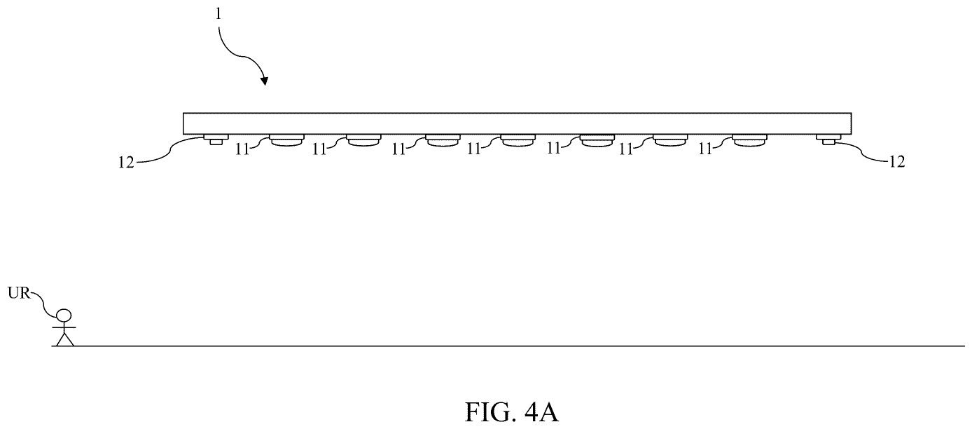

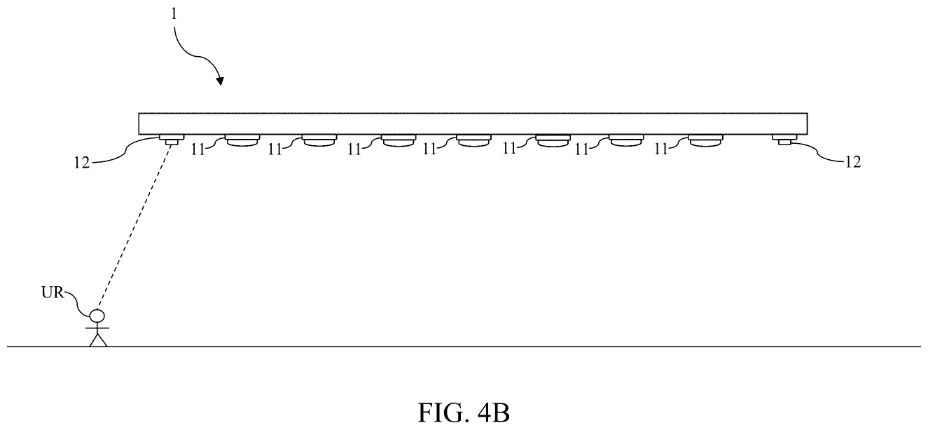

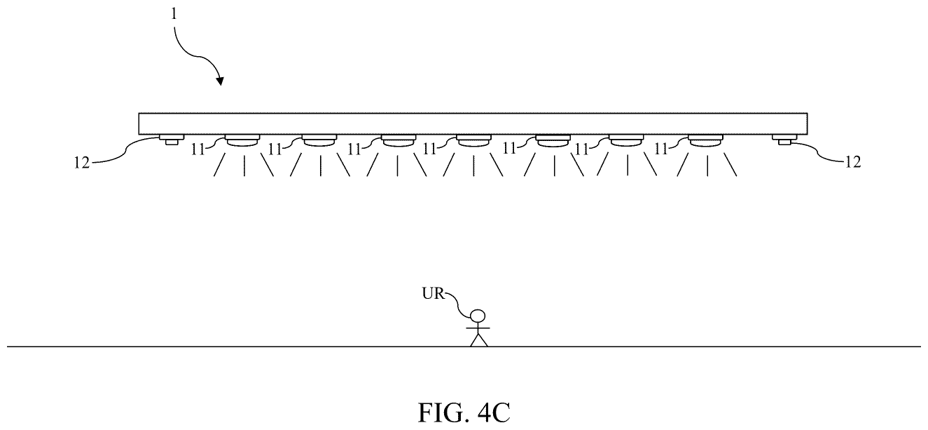

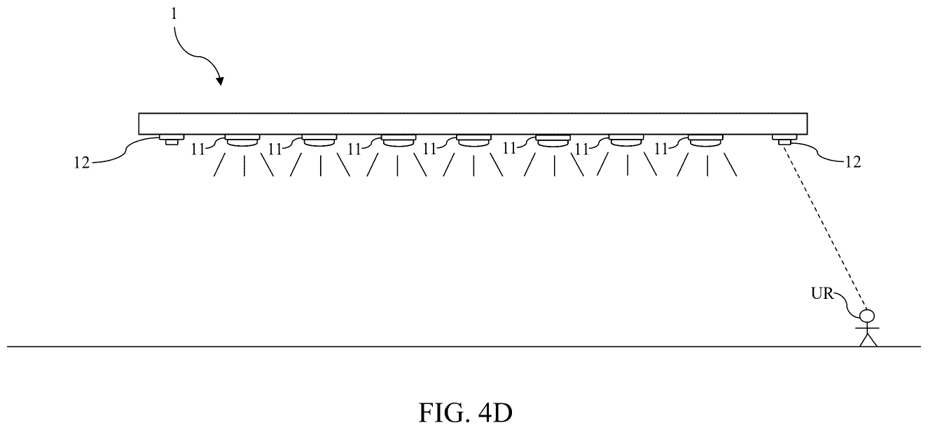

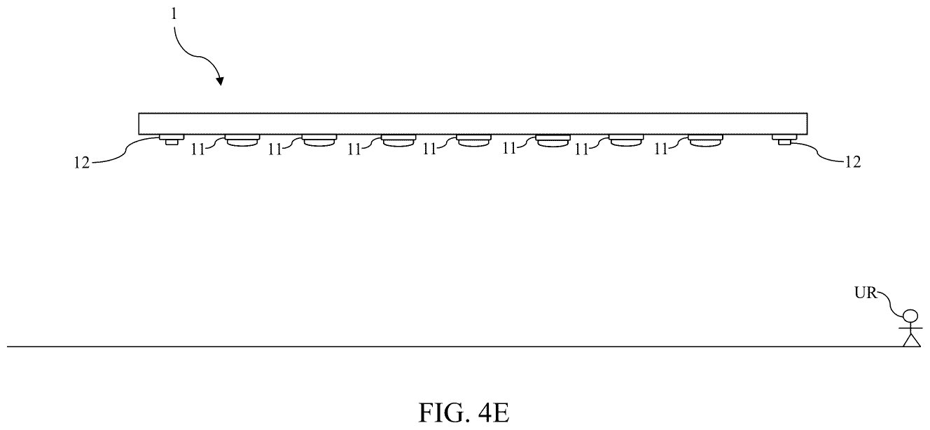

Please refer to FIG. 4A~FIG. 4E, which are schematic views of an operational process of a lighting system having intelligent predicting function in accordance with a second embodiment of the present invention respectively. The lighting system 1 includes a plurality of lighting devices 11 and a plurality of intelligent predicting sensing devices 12. As shown in FIG. 4A, the user UR moves toward a path.

As shown in FIG. 4B, when the user UR is approaching the leftmost intelligent predicting sensing device 12, the intelligent predicting sensing device 12 generates the first sensing signal after detecting the user UR and transmits the first sensing signal to the above lighting devices 11 in order to turn on these lighting devices 11 in advance.

As shown in FIG. 4C, when the user UR keeps moving along the path, the user does not perceive the process of switching the lighting devices 11 from the off state to the on state.

As shown in FIG. 4D, when the user UR is approaching the rightmost intelligent predicting sensing device 12, the intelligent predicting sensing device 12 generates the second sensing signal after detecting the user UR and transmits the second sensing signal to the above lighting devices 11.

As shown in FIG. 4E, the above lighting devices 11 calculate the delay time according to the moving speed of the user UR. Then, the lighting devices 11 are switched from the on state to the off state after the delay time passes. Similarly, the user does not perceive the process of switching the lighting devices 11 from the on state to the off state.

The embodiment just exemplifies the present invention and is not intended to limit the scope of the present invention; any equivalent modification and variation according to the spirit of the present invention is to be also included within the scope of the following claims and their equivalents.

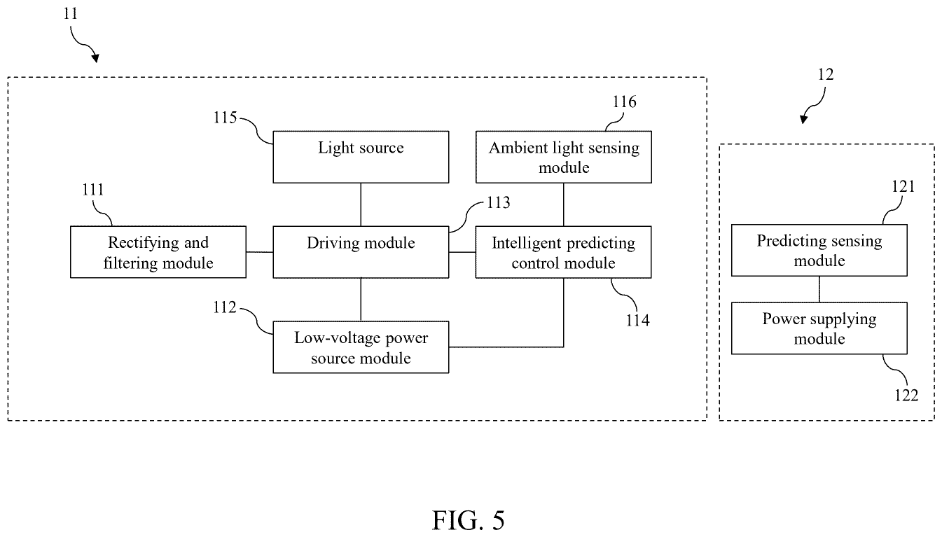

FIG. 5, which is a block diagram of a lighting device having intelligent predicting function and an intelligent predicting sensing device in accordance with a third embodiment of the present invention. As shown in FIG. 5, the lighting device 11 includes a rectifying and filtering module 111, a low-voltage power source module 112, a driving module 113, an intelligent predicting control module 114 and a light source 115.

The above elements are similar to the previous embodiment, so will not be described therein again. The difference between this embodiment and the previous embodiment is that the lighting device 11 further includes an ambient light sensing module 116. The ambient light sensing module 116 is connected to the intelligent predicting control module 114 and detects the ambient illuminance (e.g., sunlight) in order to generate an ambient light sensing signal. The intelligent predicting control module 114 adjusts the brightness of the light source 115 according to the ambient light sensing signal. As a result, when the ambient illuminance is high, the brightness of the light source 115 can be reduced so as to decrease the power consumption of the lighting device 11. On the contrary, when the brightness of the ambient illuminance is low, the brightness of the light source 115 can be increased so as to increase the ambient illuminance. The intelligent predicting control module 114 of the lighting device 11 can execute an intelligent complex calculation according to the sensing signal, sensitivity and ambient light sensing signal so as to control the light source 115. Accordingly, the operating performance of the light source 115 can be greatly enhanced.

The intelligent predicting sensing module 12 includes a predicting sensing module 121. The difference between this embodiment and the previous embodiment is that the intelligent predicting sensing device 12 further includes a power supplying module 122. The power supplying module 122 can power the predicting sensing module 121. In one embodiment, the power supplying module 122 may be a rechargeable battery, such as Li battery, NiMH battery or other similar components. Thus, the intelligent predicting sensing device 12 can have the built-in power source, so the intelligent predicting sensing device 12 does not need to be powered by the lighting device 11.

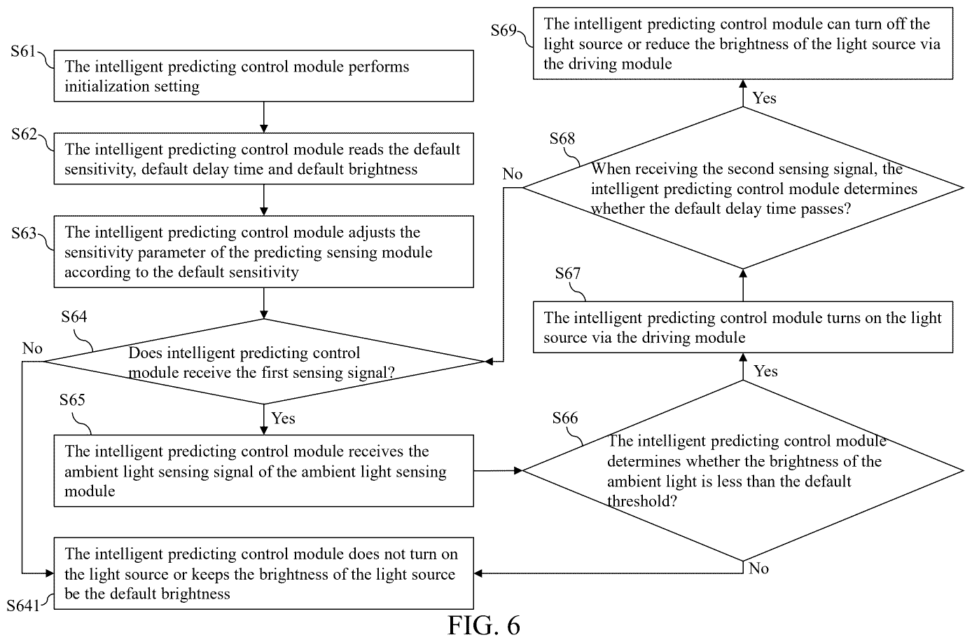

Please refer to FIG. 6, which is a flow chart of an operational mechanism of the lighting device having intelligent predicting function in accordance with a fourth embodiment of the present invention. As shown in FIG. 6, when the lighting device 11 is connected to an external power source, the intelligent predicting control module 114 can perform initialization setting, as shown in Step S61. Next, the intelligent predicting control module 114 reads the default sensitivity, default delay time and default brightness saved in the memory, as shown in Step S62. Then, the intelligent predicting control module 114 adjusts the sensitivity parameter of the predicting sensing module 121 according to the default sensitivity, as shown in Step S63. Afterward, as shown in Step S64, the intelligent predicting control module 114 determines whether the first sensing signal is received or not (the first sensing signal is generated by the intelligent predicting sensing device 12 after the intelligent predicting sensing device 12 detects the user)? If the intelligent predicting control module 114 fails to receive the first sensing signal, the intelligent predicting control module 114 does not turn on the light source 115 or keeps the brightness of the light source 115 be the default brightness, as shown in Step S641. If the intelligent predicting control module 114 receives the first sensing signal, the intelligent predicting control module 114 receives the ambient light sensing signal of the ambient light sensing module 116, as shown in Step S65. Then, as shown in Step S66, the intelligent predicting control module 114 determines whether the brightness of the ambient light is less than the default threshold according to the ambient light sensing signal? If the brightness of the ambient light is not less than the default threshold, the intelligent predicting control module 114 does not turn on the light source 115 or keeps the brightness of the light source 115 to be the default brightness, as shown in Step S641. If the brightness of the ambient light is less than the default threshold, the intelligent predicting control module 114 turns on the light source 115 via the driving module 113, as shown in Step S67. As shown in Step S68, when the intelligent predicting control module 114 receives the second sensing signal of the intelligent predicting sensing device 12 disposed at another position (the second sensing signal is generated by the intelligent predicting sensing device 12 after the intelligent predicting sensing device 12 detects the user), the intelligent predicting control module 114 determines whether the default delay time passes? If the intelligent predicting control module 114 determines that the default delay time has not passed yet, the process returns to Step S64. If the intelligent predicting control module 114 determines that the default delay time has passed, the intelligent predicting control module 114 can determine that the user has left the lighting range of the lighting device 11. In this case, the intelligent predicting control module 114 can turn off the light source 115 or reduce the brightness of the light source 115 via the driving module 113, as shown in Step S69. In another embodiment, if the lighting device 11 is not provided with the ambient light sensing module 116, the steps related to the ambient light sensing module 116 can be omitted.

The embodiment just exemplifies the present invention and is not intended to limit the scope of the present invention; any equivalent modification and variation according to the spirit of the present invention is to be also included within the scope of the following claims and their equivalents.

It is worthy to point out that the currently available lighting devices cannot turn on the light sources thereof in advance before the user reaches the lighting ranges thereof, so these lighting devices cannot improve the user experience. Besides, these lighting devices also lack the function of detecting the ambient illuminance, so the energy consumptions thereof cannot be effectively reduced. By contrast, according to one embodiment of the present invention, the lighting system includes a plurality of lighting devices and a plurality of intelligent predicting sensing devices. Any one of the lighting devices includes an intelligent predicting control module to communicate with any one of the intelligent predicting sensing devices in order to product the intelligent predicting function. Thus, when any one of the intelligent predicting sensing devices detects a moving object (e.g., a person or a vehicle) to generate a first sensing signal, the intelligent predicting sensing device can transmit the first sensing signal to the intelligent predicting control module of the lighting device corresponding thereto so as to turn on the light source of the lighting device in advance. Therefore, the user cannot perceive the process of switching this lighting device from the off state to the on state, such that the light source of this lighting device can be turned on before the user reaches the lighting range thereof.

Also, according to one embodiment of the present invention, the lighting system includes a plurality of lighting devices and a plurality of intelligent predicting sensing devices. Any one of the lighting devices has the intelligent predicting function. Accordingly, the user cannot perceive the process of switching the lighting device from the off state to the on state, such that the light source of this lighting device can be turned on before the user reaches the lighting range thereof. Therefore, the design of the lighting system can improve the user experience.

Further, according to one embodiment of the present invention, any one of the intelligent predicting sensing devices of the lighting system can detect the moving object to generate a second sensing signal and transmit the second sensing signal to the intelligent predicting control module of the lighting device corresponding thereto. Thus, the intelligent predicting control module can calculate a delay time according to the moving speed of the moving object and turn off the light source via the driving module after the delay time passes. In this way, the user does not perceive the process of switching the lighting device from the on state to the off state, which can further improve the user experience.

Moreover, according to one embodiment of the present invention, each of the lighting devices of the lighting system can further include an ambient light sensing module, which can generate an ambient light sensing signal. Therefore, the ambient light sensing module of the lighting device can adjust the brightness of the lighting source of the lighting device according to the ambient light sensing signal. In this way, when the ambient illuminance is high, the brightness of the light source of the lighting device can be decreased, which can significantly reduce the energy consumption of the lighting device.

Furthermore, according to one embodiment of the present invention, the lighting devices and intelligent predicting sensing devices of the lighting system can be connected to one another in order to form a network. Thus, the user can perform various intelligent lighting functions by managing the network. Accordingly, the lighting system can be more comprehensively in use and meet actual requirements.

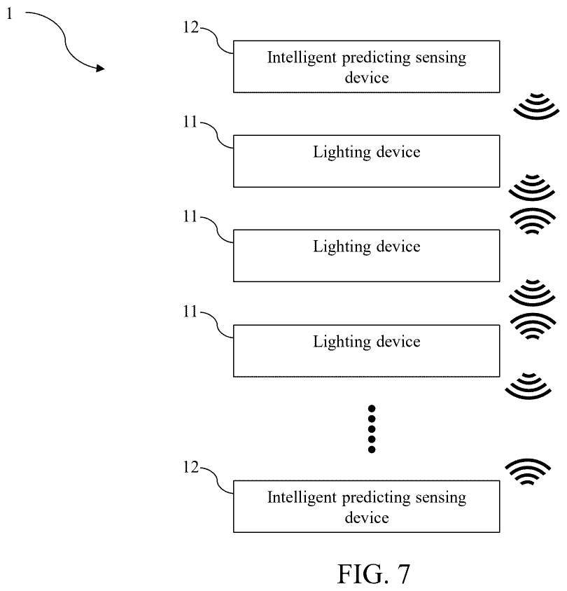

Please refer to FIG. 7, which is a block diagram of a lighting system having intelligent predicting function in accordance with a fifth embodiment of the present invention. As shown in FIG. 7, the lighting system 1 includes a plurality of lighting devices 11, two intelligent predicting sensing devices 12, and a signal relay device 13. The lighting devices 11 are distributed in a target area (such as a parking lot, an office, or a stairway). The intelligent predicting sensing devices 12 are also disposed in the target area. Each of the intelligent predicting sensing devices 12 communicates with at least one lighting device 11. The signal relay device 13 is disposed between two adjacent lighting devices 11, such that the two adjacent lighting devices 11 can communicate with each other through the signal relay device 13. The signal relay device 13 may be disposed in a specific area with poor communication quality so as to avoid communication failure caused by signal attenuation or shielding. In this embodiment, the lighting devices 11 are evenly distributed in the target area, and the two intelligent predicting sensing devices 12 are respectively disposed at the two ends of the target area. The numbers and positions of the lighting devices 11, the intelligent predicting sensing devices 12, and the signal relay device 13 may be varied according to actual requirements. In one embodiment, the signal relay device 13 may be an intelligent predicting sensing device 12 with the moving object detection function disabled. In another embodiment, the signal relay device 13 may be a Bluetooth module, a Wi-Fi module, or other similar components.

The embodiment just exemplifies the present invention and is not intended to limit the scope of the present invention; any equivalent modification and variation according to the spirit of the present invention is to be also included within the scope of the following claims and their equivalents.

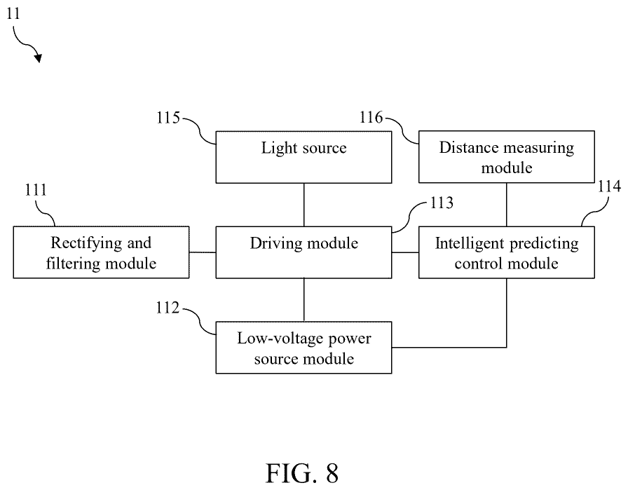

Please refer to FIG. 8, which is a block diagram of a lighting device having intelligent predicting function in accordance with the fifth embodiment of the present invention, and also refer to FIG. 7. As shown in FIG. 8, the lighting device 11 includes a rectifying and filtering module 111, a low-voltage power source module 112, a driving module 113, an intelligent predicting control module 114, and a light source 115. The rectifying and filtering module 111 is connected to an external power source (e.g., utility power), and is connected to the driving module 113 to power the driving module 113. The driving module 113 is connected to the low-voltage power source module 112, the intelligent predicting control module 114, and the light source 115. The driving module 113 powers the low-voltage power source module 112 and the light source 115, and the low-voltage power source module 112 powers the intelligent predicting control module 114.

The above components are the same as those in the foregoing embodiments and thus are not described in detail herein. The difference between this embodiment and the previous embodiments is that the lighting device 11 further includes a distance measuring module 116. The distance measuring module 116 is connected to the intelligent predicting control module 114 and detects the moving direction of a moving object. In one embodiment, the distance measuring module 116 may be a microwave sensor. In another embodiment, the distance measuring module 116 may be an infrared sensor or other components having the same or similar functions.

In addition, the intelligent predicting control module 114 of each lighting device 11 stores a plurality of lighting group setting values. One of the lighting group setting values of any lighting device 11 is identical to one of the lighting group setting values of each adjacent lighting device 1.

In another aspect, each intelligent predicting sensing device 12 may be adjacent to one lighting device 11 while maintaining a distance from the lighting device 11. The lighting device 11 may wirelessly communicate with the intelligent predicting sensing device 12 through the intelligent predicting control module 114. The intelligent predicting sensing device 12 includes a predicting sensing module 121 and a power supplying module 122 that are connected to each other. The predicting sensing module 121 stores a sensing group setting value. The power supplying module 122 supplies power to the predicting sensing module 121. The circuit structure of the intelligent predicting sensing device 12 is the same as that of the embodiment shown in FIG. 5 and thus is not described in detail herein. In another embodiment, each intelligent predicting sensing device 12 may not include the power supplying module 122, and the predicting sensing module 121 may be connected to the low-voltage power source module 112 of one lighting device 11 and receive power therefrom, as shown in FIG. 2.

When the predicting sensing module 121 detects a moving object, the predicting sensing module 121 broadcasts a first sensing signal having the sensing group setting value. Upon receiving the first sensing signal, the intelligent predicting control module 114 of the lighting device 11 controls the driving module 113 to activate the light source 115 and broadcasts a first trigger signal.

The embodiment just exemplifies the present invention and is not intended to limit the scope of the present invention; any equivalent modification and variation according to the spirit of the present invention is to be also included within the scope of the following claims and their equivalents.

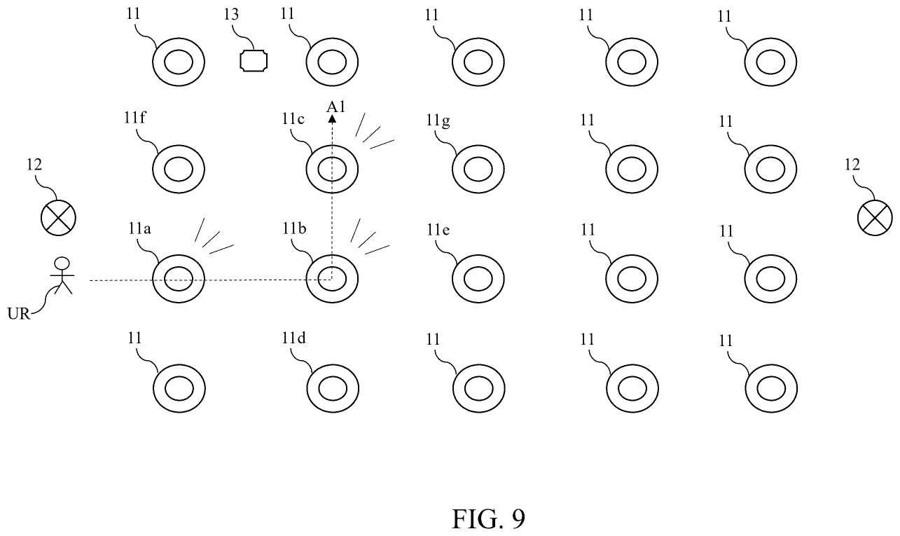

Please refer to FIG. 9, which is a first schematic views of an operating state of the lighting system having intelligent predicting function in accordance with the fifth embodiment of the present invention. As shown in FIG. 9, the lighting system 1 includes a plurality of lighting devices 11, two intelligent predicting sensing devices 12, and a signal relay device 13. For ease of explanation, seven lighting devices 11 are labeled as 11a, 11b, 11c, 11d, 11e, 11f, and 11g. The signal relay device 13 is disposed between two adjacent lighting devices 11, such that the two adjacent lighting devices 11 can communicate with each other through the signal relay device 13. The signal relay device 13 may be disposed in a specific area with poor communication quality to avoid communication failure caused by signal attenuation or shielding.

When a user UR (moving object), moves along a traveling path indicated by arrow A1, the intelligent predicting sensing device 12 on the left detects the user UR. Upon detecting the user UR, the intelligent predicting sensing device 12 broadcasts a first sensing signal having the sensing group setting value. After broadcasting the first sensing signal, the intelligent predicting sensing device 12 enters a countdown state, such as one minute, five minutes, or fifteen minutes, which may be adjusted according to actual requirements, and periodically performs the moving object detection function (rather than continuously performing the moving object detection function), so as to reduce power consumption. After the countdown state ends, the intelligent predicting sensing device 12 returns to a normal operating state in which the moving object detection function is continuously performed. The first sensing signal includes an activation command, a brightness transition time command, and a sensing group setting value, as shown in Table 1 given below:

TABLE 1

| | | |
|---|---|---|
| CMD | F3 | C1 |

CMD represents the activation command. F3 represents the brightness transition time command, indicating that the brightness transition time is three seconds. C1 represents the sensing group setting value, indicating that the intelligent predicting sensing device 12 belongs to the first group. The brightness transition time is used to control a time for each lighting device 11 to transition from the off state to the maximum brightness state or from the maximum brightness state to the off state. Through the design of the brightness transition time, the user is less likely to perceive abrupt changes caused by transitions of the lighting devices from the off state to the on state, thereby further improving comfort and safety during walking or driving. In another embodiment, the brightness transition time may be four seconds, five seconds, or six seconds, and may be adjusted according to actual requirements.

The lighting device 11a adjacent to the intelligent predicting sensing device 12 has a plurality of lighting group setting values, one of which is identical to the sensing group setting value of the intelligent predicting sensing device 12. The lighting device 11a is activated according to the first sensing signal and broadcasts a first trigger signal. The first trigger signal includes an activation command, a brightness transition time command, and a plurality of lighting group setting values, as shown in Table 2 given below:

TABLE 2

| | | | |
|---|---|---|---|
| CMD | F3 | C1 | C2 |

CMD represents the activation command. F3 represents the brightness transition time command, indicating that the brightness transition time is three seconds. C1 and C2 represent lighting group setting values, indicating that the lighting device 11a belongs to both the first group and the second group.

Since one lighting group setting value C1 of the lighting device 11a is identical to that of the intelligent predicting sensing device 12, only the lighting device 11a responds to the first trigger signal. Other lighting devices 11 may also receive the first sensing signal. However, since the lighting group setting values of those lighting devices 11 are different from the sensing group setting value C1 of the intelligent predicting sensing device 12, they do not respond to the first sensing signal.

After being activated according to the first sensing signal, the lighting device 11a transitions from the off state to the maximum brightness state according to the brightness transition time. After reaching the maximum brightness state, the lighting device 11a transitions from the maximum brightness state to the off state according to the brightness transition time. The brightness control mechanism of the lighting device 11a may be adjusted according to actual requirements.

The lighting device 11b adjacent to the lighting device 11a also has a plurality of lighting group setting values, one of which is identical to the sensing group setting value of the lighting device 11a. Meanwhile, the lighting device 11b detects the moving direction of the user UR to determine whether the user UR is approaching or moving away from the lighting device 11b. When the lighting device 11b determines that the user UR is approaching, the lighting device 11b is activated according to the first trigger signal and broadcasts a second trigger signal. Conversely, when the lighting device 11b determines that the user UR is moving away, the lighting device 11b remains in the standby state. The second trigger signal includes an activation command, a brightness transition time command, and a plurality of lighting group setting values, as shown in Table 3 given below:

TABLE 3

| | | | |
|---|---|---|---|
| CMD | F3 | C2 | C3 |

CMD represents the activation command. F3 represents the brightness transition time command, indicating that the brightness transition time is three seconds. C2 and C3 represent lighting group setting values, indicating that the lighting device 11b belongs to both the second group and the third group.

Since one lighting group setting value C2 of the lighting device 11b is identical to that of the lighting device 11a, only the lighting device 11b and other lighting devices 11 having the lighting group setting value C2 respond to the first trigger signal. Other lighting devices 11 may also receive the first trigger signal. However, since the lighting group setting values of those lighting devices 11 are different from the lighting group setting value C2 of the lighting device 11a, they do not respond to the first trigger signal.

After being activated according to the first trigger signal, the lighting device 11b transitions from the off state to the maximum brightness state according to the brightness transition time. After reaching the maximum brightness state, the lighting device 11b transitions from the maximum brightness state to the off state according to the brightness transition time. The brightness control mechanism of the lighting device 11b may be adjusted according to actual requirements.

Through the moving direction detection mechanism described above, only lighting devices located along the traveling path of the user UR are activated, while lighting devices not located along the traveling path of the user UR are not activated. For example, although the lighting devices 11d and 11e also have the lighting group setting value C2, since the moving direction of the user UR is away from the lighting devices 11d and 11e, the lighting devices 11d and 11e remain in the standby state even if they receive the first trigger signal.

The lighting device 11c adjacent to the lighting device 11b also has a plurality of lighting group setting values, one of which is identical to the sensing group setting value of the lighting device 11b. Meanwhile, the lighting device 11c detects the moving direction of the user UR to determine whether the user UR is approaching or moving away from the lighting device 11c. When the lighting device 11c determines that the user UR is approaching, the lighting device 11c is activated according to the second trigger signal and broadcasts a third trigger signal. Conversely, when the lighting device 11c determines that the user UR is moving away, the lighting device 11c remains in the standby state. The third trigger signal includes an activation command, a brightness transition time command, and a plurality of lighting group setting values, as shown in Table 4.

TABLE 4

| | | | |
|---|---|---|---|
| CMD | F3 | C3 | C4 |

CMD represents the activation command. F3 represents the brightness transition time command, indicating that the brightness transition time is three seconds. C3 and C4 represent lighting group setting values, indicating that the lighting device 11c belongs to both the third group and the fourth group.

Since one lighting group setting value C3 of the lighting device 11c is identical to that of the lighting device 11b, only the lighting device 11c and other lighting devices 11 having the lighting group setting value C3 respond to the second trigger signal. Other lighting devices 11 may also receive the second trigger signal. However, since the lighting group setting values of those lighting devices 11 are different from the lighting group setting value C3 of the lighting device 11b, they do not respond to the second trigger signal.

After being activated according to the second trigger signal, the lighting device 11c transitions from the off state to the maximum brightness state according to the brightness transition time. After reaching the maximum brightness state, the lighting device 11c transitions from the maximum brightness state to the off state according to the brightness transition time. The brightness control mechanism of the lighting device 11c may be adjusted according to actual requirements.

Through the moving direction detection mechanism described above, only lighting devices located along the traveling path of the user UR are activated, while lighting devices not located along the traveling path of the user UR are not activated. For example, although the lighting devices 11f and 11g also have the lighting group setting value C3, since the moving direction of the user UR is away from the lighting devices 11f and 11g, the lighting devices 11f and 11g remain in the standby state even if they receive the second trigger signal.

As described above, in this embodiment, the lighting system 1 has an intelligent predicting mechanism based on lighting device group settings. The lighting system 1 not only pre-activates the lighting devices 11 upon detection of a moving object (e.g., a person or a vehicle), but also accurately predicts the traveling path of the moving object. Accordingly, the lighting devices 11 can sequentially and in advance provide sufficient illumination along the traveling path, such that the user UR does not perceive abrupt changes caused by transitions of the lighting devices 11 from the off state to the on state during actual movement, thereby significantly improving comfort and safety during walking or driving. Meanwhile, the lighting system 1 is also more energy efficient. Therefore, the lighting system 1 effectively satisfies actual requirements.

In addition, in this embodiment, through the above-described moving direction detection mechanism, only the lighting devices 11 located along the traveling path of the user UR are activated, while the lighting devices 11 not located along the traveling path of the user UR are not activated. Accordingly, the lighting system 1 not only ensures that the lighting devices 11 sequentially and in advance provide sufficient illumination along the traveling path, but also further improves energy efficiency.

The embodiment just exemplifies the present invention and is not intended to limit the scope of the present invention; any equivalent modification and variation according to the spirit of the present invention is to be also included within the scope of the following claims and their equivalents.

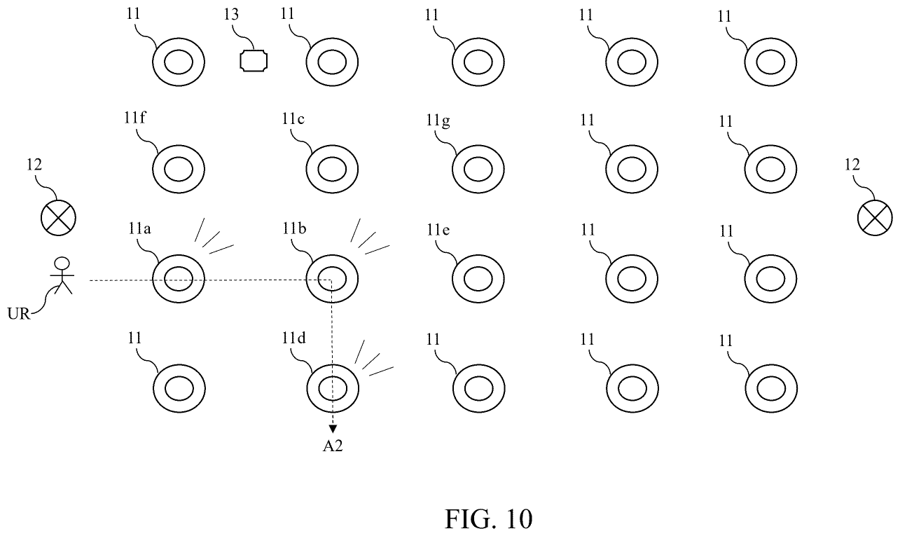

Please refer to FIG. 10, which is a second schematic diagram illustrating the operating state of the intelligent lighting system having the intelligent predicting function according to the fifth embodiment of the present invention. As shown in the drawing, when the user UR (moving object) moves along a traveling path indicated by arrow A2, the traveling path only passes through the lighting devices 11a, 11b, and 11d. Therefore, only the lighting devices 11a, 11b, and 11d are sequentially activated, while the other lighting devices 11 remain inactive.

The embodiment just exemplifies the present invention and is not intended to limit the scope of the present invention; any equivalent modification and variation according to the spirit of the present invention is to be also included within the scope of the following claims and their equivalents.

As described above, according to one embodiment of the present invention, the lighting system includes a plurality of lighting devices and at least one intelligent predicting sensing device. The lighting devices are distributed in a target area. Each of the lighting devices stores a plurality of lighting group setting values, and one of the lighting group setting values of any one of the lighting devices is identical to one of the lighting group setting values of the lighting device adjacent thereto. The intelligent predicting sensing device is disposed in the target area and in communication with at least one of the lighting devices. The intelligent predicting sensing device stores a sensing group setting value, and the sensing group setting value is identical to one of the lighting group setting values of the lighting device adjacent thereto. The intelligent predicting sensing device broadcasts, upon detecting a moving object, a first sensing signal having the sensing group setting value, and the lighting device receiving the first sensing signal is activated and to broadcast a first trigger signal based on the first sensing signal. The first trigger signal has the lighting group setting values of the lighting device receiving the first trigger signal. As described above, the lighting system has an intelligent predicting mechanism based on lighting device group settings, which not only pre-activates lighting devices upon detection of a moving object (e.g., a person or a vehicle), but also accurately predicts the traveling path of the moving object. Accordingly, the lighting devices can sequentially and in advance provide sufficient illumination along the traveling path, such that the user does not perceive abrupt changes caused by transitions of the lighting devices from the off state to the on state during actual movement, thereby significantly improving comfort and safety during walking or driving. Meanwhile, the lighting system is also more energy efficient. Therefore, the lighting system effectively satisfies actual requirements.

Also, according to one embodiment of the present invention, the lighting device receiving the first trigger signal detects the moving direction of the moving object, and is activated and broadcasts a second trigger signal when the moving direction of the moving object is approaching the lighting device. The second trigger signal includes the lighting group setting values of the lighting device receiving the first trigger signal. Conversely, when the moving direction of the moving object is moving away from the lighting device, the lighting device does not broadcast the second trigger signal and remains in the standby state. Through the above-described moving direction detection mechanism, only lighting devices located along the traveling path of the moving object are activated, while lighting devices not located along the traveling path of the moving object are not activated. Accordingly, the lighting system not only ensures that the lighting devices sequentially and in advance provide sufficient illumination along the traveling path, but also further improves energy efficiency.

Further, according to one embodiment of the present invention, the intelligent predicting sensing device further stores a brightness transition time, such that the first sensing signal includes the brightness transition time. The brightness transition time controls a time for each lighting device to transition from the off state to the maximum brightness state or from the maximum brightness state to the off state. Accordingly, the user is less likely to perceive abrupt changes caused by transitions of the lighting devices from the off state to the on state, thereby further improving comfort and safety during walking or driving.

Moreover, according to one embodiment of the present invention, after broadcasting the first sensing signal, the intelligent predicting sensing device enters a countdown state and periodically performs the moving object detection function. Accordingly, the intelligent predicting sensing device does not need to continuously perform the moving object detection function during the countdown state, but only needs to periodically perform the moving object detection function. As a result, the power consumption of the intelligent predicting sensing device can be further reduced.

Furthermore, according to one embodiment of the present invention, the lighting system further includes a signal relay device. The signal relay device may be disposed between two adjacent lighting devices to establish or enhance a communication link between the lighting devices. By disposing the signal relay device in a specific area with poor communication quality, communication failure caused by signal attenuation or shielding can be effectively avoided, thereby ensuring communication stability and normal operation of the overall lighting system.

It will be apparent to those skilled in the art that various modifications and variations can be made to the disclosed embodiments. It is intended that the specification and examples be considered as exemplary only, with a true scope of the present invention being indicated by the following claims and their equivalents.

What is claimed is:

1. A lighting system having intelligent predicting function, comprising:
a plurality of lighting devices distributed in a target area, wherein each of the lighting devices is configured to store a plurality of lighting group setting values, and one of the lighting group setting values of any one of the lighting devices is identical to one of the lighting group setting values of the lighting device adjacent thereto; and
at least one intelligent predicting sensing device disposed in the target area and in communication with at least one of the lighting devices, wherein the intelligent predicting sensing device is configured to store a sensing group setting value, and the sensing group setting value is identical to one of the lighting group setting values of the lighting device adjacent thereto;
wherein the intelligent predicting sensing device is configured to, upon detecting a moving object, broadcast a first sensing signal having the sensing group setting value, and the lighting device receiving the first sensing signal is configured to be activated and to broadcast a first trigger signal based on the first sensing signal, and the first trigger signal has the lighting group setting values of the lighting device receiving the first trigger signal.

2. The lighting device having intelligent predicting function as claimed in claim 1, wherein the lighting device receiving the first trigger signal is configured to detect a moving direction of the moving object and, when the moving object is approaching the lighting device receiving the first trigger signal, to be activated and to broadcast a second trigger signal, wherein the second trigger signal has the lighting group setting values of the lighting device receiving the second trigger signal.

3. The lighting device having intelligent predicting function as claimed in claim 1, wherein the lighting device receiving the first trigger signal is configured to detect a moving direction of the moving object and to remain in a standby state when the moving object is moving away from the lighting device receiving the first trigger signal.

4. The lighting device having intelligent predicting function as claimed in claim 1, wherein each of the lighting devices comprises a driving module, a light source, and an intelligent predicting control module, wherein the light source and the intelligent predicting control module are connected to the driving module, and the intelligent predicting control module is configured to, upon receiving the first sensing signal, turn on the light source via the driving module.

5. The lighting system having intelligent predicting function as claimed in claim 4, wherein each of the lighting devices further comprises a low-voltage power source module connected to the driving module, the intelligent predicting control module and the intelligent predicting sensing device, wherein the driving module is configured to power the low-voltage power source module, and the low-voltage power source module is configured to power the intelligent predicting control module.

6. The lighting device having intelligent predicting function as claimed in claim 1, wherein each of the lighting devices further comprises a distance measuring module connected to the intelligent predicting control module and configured to detect the moving direction of the moving object.

7. The lighting device having intelligent predicting function as claimed in claim 1, wherein the intelligent predicting sensing device comprises a predicting sensing module and a power supplying module, and the power supplying module is configured to power the predicting sensing module, and the predicting sensing module is configured to generate the first sensing signal.

8. The lighting device having intelligent predicting function as claimed in claim 1, further comprising a signal relay device disposed between two of the lighting devices adjacent to each other.

9. The lighting device having intelligent predicting function as claimed in claim 1, wherein the intelligent predicting sensing device is further configured to store a brightness transition time, whereby the first sensing signal has the brightness transition time, and wherein the brightness transition time is used to control a time for each of the lighting devices to transition from an off state to a maximum brightness state or from the maximum brightness state to the off state.

10. The intelligent lighting system of claim 1, wherein the intelligent predicting sensing device is configured to enter a countdown state after broadcasting the first sensing signal and to periodically perform a moving object detection function.
